(19) United States
(12) Patent Application Publication
(10) Pub. No.: US 2018/0240392 A1
(43) Pub. Date: Aug. 23, 2018

(54) THIN FILM TRANSISTOR (TFT) LIQUID CRYSTAL DISPLAY (LCD) PANEL

(71) Applicant: Solomon Systech Limited, Hong Kong (HK)

(72) Inventors: Jun Chen, Hong Kong (HK); Yiu Sang Lei, Hong Kong (HK); Shu Shing Ching, Hong Kong (HK); Cheung Fai Lee, Hong Kong (HK)

(21) Appl. No.: 15/438,748

(22) Filed: Feb. 21, 2017

(51) Int. Cl. G09G 3/20; G02F 1/1345; G02F 1/1368; G02F 1/1362; G09G 3/36

(52) U.S. Cl. CPC G09G 3/2077; G09G 2320/0626; G02F 1/1368; G02F 1/136286; G09G 3/2003; G09G 3/3607; G09G 3/3677; G09G 3/3688; G09G 2300/0452; G09G 2360/18; G09G 2310/0251; G09G 2354/00; G09G 2330/023; G09G 2320/0257; G02F 1/13454

(57) ABSTRACT

Disclosed is a thin film transistor (TFT) liquid crystal display (LCD) panel. The TFT LCD panel may comprise a matrix of data bus lines and scan bus lines arranging sub-pixels. The TFT LCD may comprise gate drivers, configured to sequentially activate TFTs of sub-pixels belonging to the scan bus lines. The TFT LCD panel may comprise source drivers, configured to charge sub-pixels of the scan bus lines to render an image on the TFT LCD panel. The TFT LCD may further comprise an amplitude variation unit to compare an amplitude change on a data bus line driven by a source driver based on the image data of current scan bus line and previous scan bus line corresponding to the data bus line. The amplitude variation unit may modify the amplitude on the data bus line by a predefined value if the amplitude change is greater than a predefined threshold value.

### TECHNICAL FIELD

The present application described herein, in general, relates to an electronic device display panel. In particular, the present application relates to a thin film transistor (TFT) liquid crystal display (LCD) panel.

### BACKGROUND

Recently, technological advanced liquid crystal display (LCD) panels have been developed in order to cater numerous customer-centric applications. With the flourishing development in the technology of display panels, it is a market and customer demand for high performance LCD display panels. The LCD display panels providing high resolution, high brightness and low-power consumption are most preferred. However, it is observed that, with increase in resolution of the display panel, the quantity of sub-pixels on the display panel also increases. This eventually, leads to an increased panel size as well as increased monetary cost of the display panels.

In case of high resolution display panels, an efficient panel driving scheme for their display drivers is required. As the display panel size increases, the display line time to drive the panel loading of the display panel turn out to be too short. This leads to larger power consumption and creates visual defects such as dim lining effect for killer patterns. However, a die height can be increased to enhance the performance of the display panel but the performance will be still limited to a short display line time.

### SUMMARY

This summary is provided to introduce concepts related to a thin film transistor (TFT) liquid crystal display (LCD) panel and the concepts are further described below in the detailed description. This summary is not intended to identify essential features of the claimed subject matter nor is it intended for use in determining or limiting the scope of the claimed subject matter.

In one embodiment, a thin film transistor (TFT) liquid crystal display (LCD) panel is disclosed. The thin film transistor (TFT) liquid crystal display (LCD) panel may comprise a matrix of data bus lines and scan bus lines arranging a plurality of sub-pixels, wherein an intersection of a data bus line and a scan bus line, in the matrix, is a cell depicting a sub-pixel of the plurality of sub-pixels, and wherein each sub-pixel may comprise a TFT. The TFT LCD panel may further comprise a plurality of gate drivers connected with a gate terminal of a plurality of TFTs of the plurality of sub-pixels via the scan bus lines, wherein the plurality of gate drivers may be configured to sequentially activate the TFTs of multiple sub-pixels, of the plurality of sub-pixels, belonging to one scan bus line after the other. The TFT LCD panel may further comprise a plurality of source drivers connected with a source terminal of the plurality of TFTs of the plurality sub-pixels via the data bus lines, wherein the plurality of source drivers may be configured to charge the multiple sub-pixels on each scan bus line being activated, one after the other, by the plurality of gate drivers, and wherein multiple sub-pixels on a scan bus line are charged to render an image on the TFT LCD panel based upon image data corresponding to the multiple sub-pixels on the said scan bus line. Furthermore, the TFT LCD panel may comprise an amplitude variation unit coupled with a source driver of the plurality of source drivers. In one embodiment, the amplitude variation unit may be configured to compare an amplitude change on a data bus line, driven by the said source driver, based upon the image data of a current scan bus line and a previous scan bus line corresponding to the said data bus line. The amplitude variation unit may further be configured to modify the amplitude of the said data bus line by a predefined value if the amplitude change on the said data bus line is greater than a predefined threshold value.

In another embodiment, a method enabling adaptive source driving for a thin film transistor (TFT) liquid crystal display (LCD) panel is disclosed. The method may comprise providing a TFT LCD panel in form of matrix comprising data bus lines and scan bus lines arranging a plurality of sub-pixels, wherein an intersection of a data bus line and a scan bus line, in the matrix, is a cell depicting a sub-pixel of the plurality of sub-pixels, and wherein each sub-pixel may comprise a TFT. The method may further comprise sequentially activating, via a plurality of gate drivers, TFTs of multiple sub-pixels, of the plurality of sub-pixels, belonging to one scan bus line after the other, wherein the plurality of gate drivers may be connected to a gate terminal of the plurality of TFTs of the plurality of sub-pixels via the scan bus lines. The method may further comprise providing, via a plurality of source drivers, a charge to the multiple sub-pixels belonging to each scan bus line being activated, one after the other, by the plurality of gate drivers, wherein multiple sub-pixels on a scan bus line are charged to render an image on the TFT LCD panel based upon image data corresponding to the multiple sub-pixels on the said scan bus line. The plurality of source drivers may be connected to a source terminal of the plurality of TFTs of the plurality of sub-pixels via the data bus lines. Further the method may comprise comparing, via an amplitude variation unit coupled with a source driver of the plurality of source drivers, an amplitude change on a data bus line, driven by the said data bus line, based upon the image data of a current scan bus line and a previous scan bus line corresponding to the said data bus line. Furthermore, the method may comprise modifying, via the amplitude variation unit, amplitude on the said data bus line by a predefined threshold value if the amplitude change on the data bus line is greater than a predefined threshold value.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a TFT LCD panel 100, in accordance with an embodiment of the present application.

FIG. 2(a) and FIG. 2(b) illustrate a physical structure 200 of a sub-pixel 105 comprising a storage capacitor (C_{S}) connected to a scan line and a circuit diagram 205 representing the physical structure 200, in accordance with an embodiment of the present application.

FIG. 3(a) and FIG. 3(b) illustrate a physical structure 300 of a sub-pixel 105 comprising a storage capacitor (C_{S}) connected to a common electrode and a circuit diagram 301 representing the physical structure 300, in accordance with an embodiment of the present application.

FIG. 4 illustrates a panel loading electrical model 400 for the TFT LCD panel 100, in accordance with an embodiment of the present application.

FIG. 5 illustrates a channel loading electrical model 500 for the TFT LCD panel 100, in accordance with an embodiment of the present application.

FIG. 6(a) and FIG. 6(b) illustrate a channel loading effect 600 on each sub-pixel of the TFT LCD panel 100 and a symbol representation 603 for the channel loading effect 600, in accordance with the embodiment of the present application.

FIG. 7 illustrates an adaptive amplitude logic unit implementation 700 of an amplitude variation unit coupled with the source drivers 101, in accordance with an embodiment of the present application.

FIG. 8 illustrates an amplitude change limiting filter-based implementation 800 of an amplitude variation unit coupled with the source drivers 101, in accordance with an embodiment of the present application.

FIG. 9 illustrates a block diagram 900 of the adaptive amplitude logic unit implementation 700, in accordance with an embodiment of the present application.

FIG. 10 illustrates a block diagram 1000 of the amplitude change limiting filter-based implementation 800, in accordance with an embodiment of the present application.

FIG. 11 illustrates a method 1100 enabling adaptive source driving for a thin film transistor (TFT) liquid crystal display (LCD) panel, in accordance with an embodiment of the present application.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

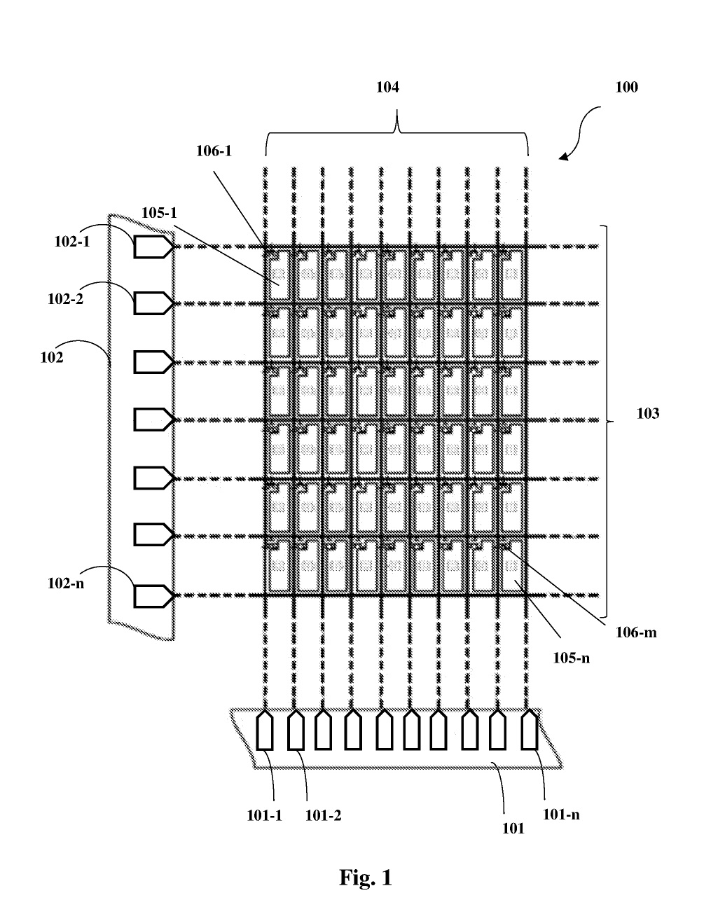

Referring to FIG. 1, a physical structure of a TFT LCD panel 100 is illustrated, in accordance with an embodiment of the present application. The TFT LCD panel 100 may comprise a plurality of source drivers 101-1,101-2 . . . 101-n (collectively referred hereinafter as source drivers 101), a plurality of gate drivers 102-1,102-2 . . . 102-n (collectively referred hereinafter as gate drivers 102), a plurality of scan bus lines 103 connected with the gate drivers 102, a plurality of data bus lines 104 connected with the source drivers 101, a plurality of sub-pixels 105-1, 105-2 . . . 105-n, and a plurality of TFTs 106-1, 106-2 . . . 106-m. In an embodiment, the source drivers 101 and the gate drivers may be configured to drive the plurality of data lines 104 and the plurality of scan lines 103 respectively. In one embodiment, a matrix of the sub-pixels 105-1, 105-2 . . . 105-n for the TFT LCD panel 100 may be formed by intersection of the data bus lines 104 and the scan bus lines 103. Further, in the matrix, a cell depicts a sub-pixel 105 of the plurality of sub-pixels. As shown in FIG. 1, each sub-pixel 105 may comprise a TFT 106. The gate drivers 102 may be connected with a gate terminal of the TFT 106 of each sub-pixel 105 via the scan bus lines 103. The gate drivers 102 may be configured to sequentially activate the TFTs 106-1, 106-2 . . . 106-m of the sub-pixels belonging to one scan bus line after the other. The source drivers 101 may be connected with a source terminal of the TFTs 106 via the data bus lines 104. The source drivers 101 may be configured to provide an analog voltage to the TFTs 106 of multiple sub-pixels belonging to each scan bus line 103 being activated, one after the other, by the said gate drivers 102. In an embodiment, the said analog voltage may be provided to charge multiple sub-pixels on a scan bus line of the scan bus lines 103 to render an image on the TFT LCD panel 100 based upon input image data corresponding to the multiple sub-pixels on the said scan bus line of the scan bus lines 103.

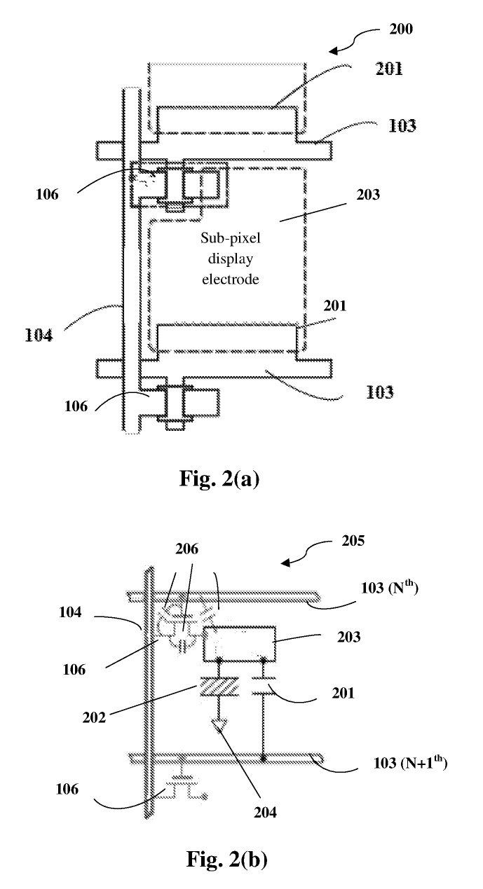

Referring now to FIG. 2(a) and FIG. 2(b), a physical structure 200 of a sub-pixel 105 comprising a storage capacitor (Cs) connected to a scan bus line and a circuit diagram 205 representing the physical structure 200 is shown, in accordance with an embodiment of the present application. Each sub-pixel 105 may comprise a TFT 106, a storage capacitor 201 and a liquid crystal capacitor 202. The storage capacitor 201 may be adapted to maintain a stable voltage across the liquid crystal capacitor 202 until the next fresh cycle. Further, one plate of the storage capacitor 201 may be formed by a display electrode 203 and the other plate may be formed by using the scan bus lines 103.

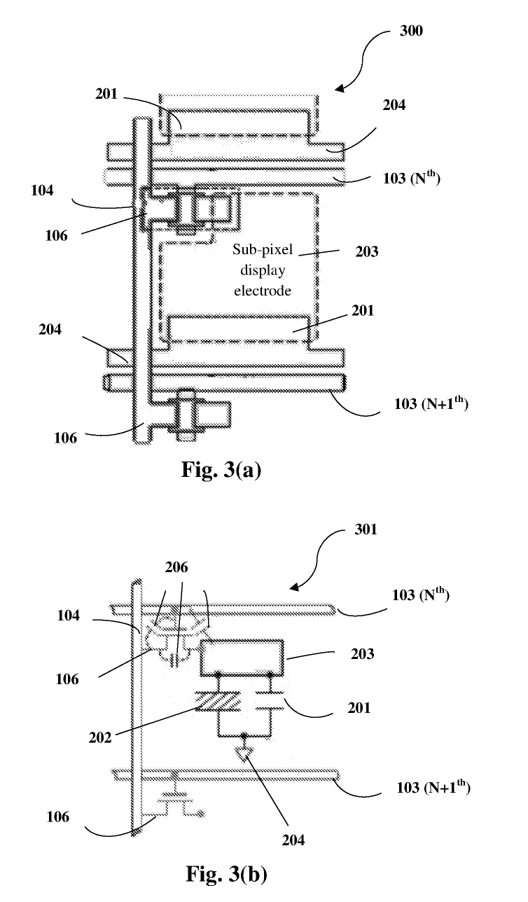

Now, referring to FIG. 3(a) and FIG. 3(b), a physical structure 300 of a sub-pixel 105 comprising the storage capacitor (C_{S}) connected to a common electrode and a circuit diagram 301 representing the physical structure 300 is shown, in accordance with an embodiment of the present application. Each sub-pixel 105 may comprise a TFT 106, a storage capacitor 201 and a liquid crystal capacitor 202. The storage capacitor 201 may be adapted to maintain a stable voltage across the liquid crystal capacitor 202 until the next fresh cycle. Further, one plate of the storage capacitor may be formed by a display electrode 203 and the other plate may be formed by using a common electrode 204.

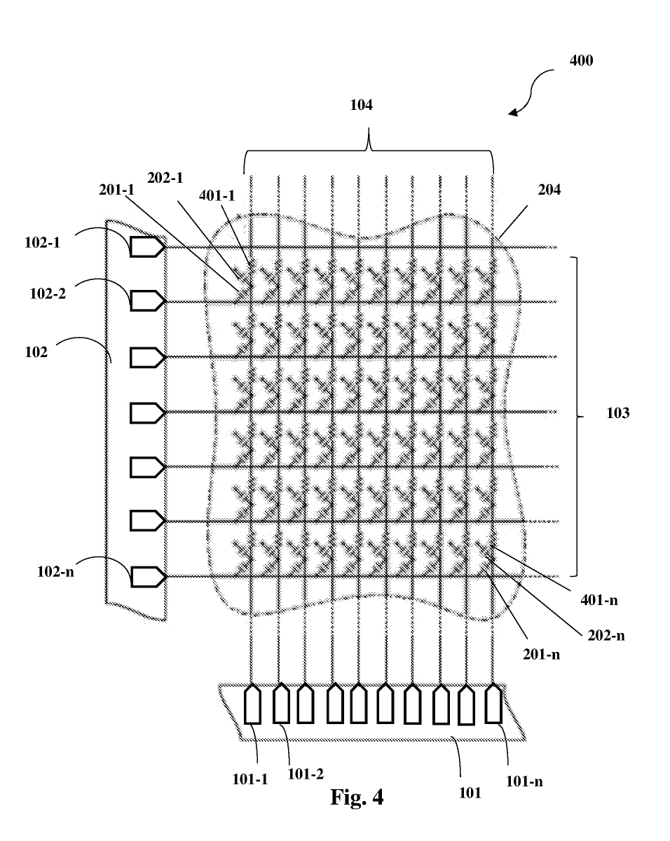

As shown in FIG. 2(b) and FIG. 3(b), the TFT 106 may be surrounded by parasitic capacitors 206 ensuring that even if a particular scan bus line from the scan bus lines 103 is not activated, the corresponding sub-pixel 105 can have effect on a panel loading model explained in details in subsequent paragraphs with reference to FIG. 4. Further, as shown in FIG. 2(b) and FIG. 3(b), a plurality of source signals generated from the source drivers 101 may be partially coupled to the scan bus lines 103 and the common electrode 204 through the parasitic capacitance 206 coupled between the scan bus lines and a data bus line.

Referring to FIG. 4, a panel loading electrical model 400 for the TFT LCD panel 100 is illustrated, in accordance with an embodiment of the present application. The panel loading electrical model 400 may comprise the gate drivers 102, the source drivers 101, the scan bus lines 103, the data bus lines 104, the common electrode 204, a plurality of storage capacitors 201-1, 201-2 . . . 201-n, a plurality of liquid crystal capacitors 202-1, 201-2 . . . 202-n and a plurality of resistors 401-1, 401-2 . . . 401-n. In one embodiment, for each section of data bus lines 104 there may be a resistor 401 and two capacitors 201 and 202. The resistor 401 per section may represent a resistance of the section of the common electrode 204 and a resistance of the section of data bus lines 104. The storage capacitor 201 may connect to the scan bus lines 103 and the liquid crystal capacitor 202 may connect to the common electrode 204.

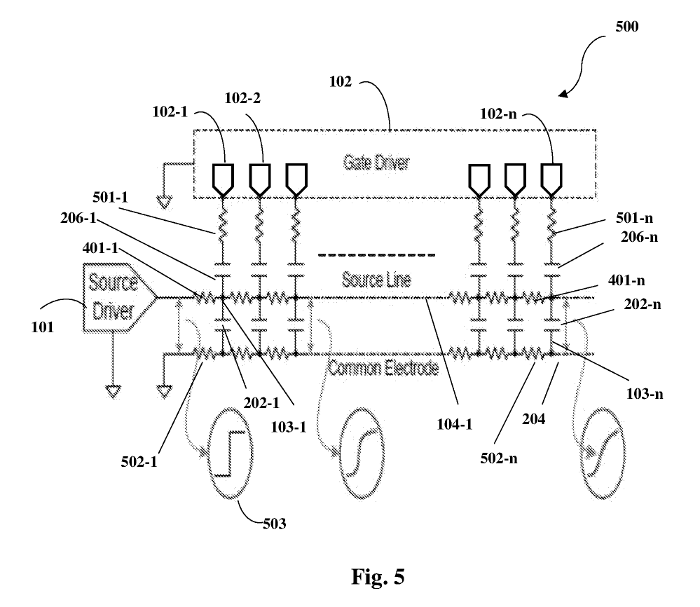

Now referring to FIG. 5, a channel loading electrical model 500 for the TFT LCD panel 100 is illustrated, in accordance with an embodiment of the present application. The channel loading electrical model 500 may comprise a source driver of the plurality of source drivers 101, the gate drivers 102, a data bus line 104, scan bus lines 103, a common electrode 204, a plurality of routing resistance of scan bus lines 501-1, 501-2 501-n, a plurality of resistors 401-1, 401-2 . . . 401-n, a plurality of parasitic capacitance 206-1, 206-2 . . . 206-n coupled between scan bus lines and a data bus line, a plurality of liquid crystal display capacitors 202-1, 202-2 . . . 202-n and a plurality of common electrode resistors 502-1, 502-2 502-n. In one embodiment, one plate of the parasitic capacitance 206 coupled between scan bus lines and a data bus line may be formed by the display electrode 203 and the other plate may be formed by using the scan bus lines 103. Each common electrode resistor 502 may represent a resistance of the section of the common electrode 204 and each resistor 401 may represent resistance of the section of data bus lines 104. One plate of the liquid crystal capacitor 202 may be connected to the data bus lines 104 and the other plate may be connected to the common electrode 204. In one embodiment, during a frame fresh, the gate drivers 102 may turn on and off the TFTs 106-1, 106-2 . . . 106-m, one scan bus line after the other. A source driver from plurality of source drivers 101 may charge a whole data bus line 104-1 of sub-pixels to their targeted voltage level 503 during the on period before the gate drivers 102 switch off the TFTs 106 on the scan bus lines 103. In FIG. 5, each sub-pixel 105 is represented with the panel loading electrical model 400 comprising the parasitic capacitance 206 coupled between scan bus lines and a data bus line, the liquid crystal display capacitor 202 and the resistor 401. Further, the gate drivers 102 may switch on the TFTs on the following scan bus lines 103. A source driver from plurality of source drivers 101 may charge the following data bus lines 104-2 of the sub-pixels in a similar way. The said process may continue until the last scan bus line 103-n and data bus line 104-n. It may be difficult to make the potential difference of the sub-pixels that are far from the source drivers 101 to charge up to the targeted voltage level 503 as compared to the sub-pixels near to the source drivers 101. The source drivers 101 may change targeted voltage level 503 extremely fast, the delay line nature of the channel loading electrical model 500 may cause the targeted voltage level 503 to propagate slowly to the sub-pixel 105.

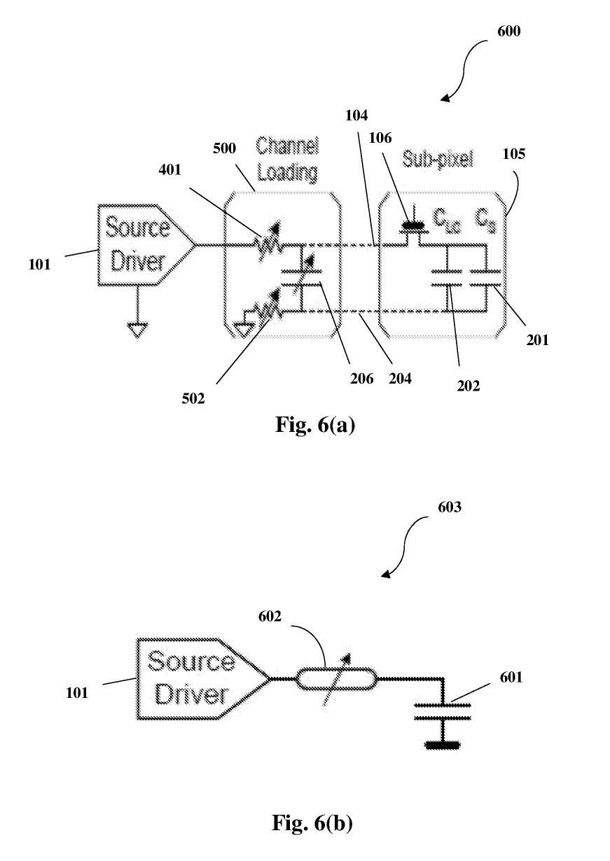

Now referring to FIG. 6(a) and FIG. 6(b), a channel loading effect 600 on each sub-pixel of the TFT LCD panel 100 and a symbol representation 603 for the channel loading effect 600 is illustrated, in accordance with the embodiment of the present application. In one embodiment, the channel loading effect on each sub-pixel 105 may comprise a source driver of the plurality of source drivers 101, the sub-pixel 105, the channel loading electrical model 500. The sub-pixel 105 may further comprise the TFT 106, the liquid crystal capacitor 202 and the parasitic capacitance 206 coupled between scan bus lines and a data bus line. As shown, one plate of the parasitic capacitance 206 coupled between the scan bus lines and a data bus line and the liquid crystal display capacitor 202 may be connected to the data bus line 104 and the other plate may be connected to the common electrode 204. The channel loading electrical model 500 applied on the sub-pixel 105 may further comprise the liquid crystal capacitor 202, the resistor 401 and the common electrode resistor 502. In one embodiment, the symbol of FIG. 6(b) may comprise a panel loading 602, a source driver of the plurality of source drivers 101 and output capacitor 601. The panel loading 602 may comprise a combination of sub-pixels 105-1, 105-2 105-n applied with effect of channel loading electrical model 500 as shown in FIG. 5.

The effect of channel loading electrical model 500 upon the liquid crystal capacitor 202 may be that the light intensity coming out from the sub-pixel 105 may be determined by the potential difference between the upper plate and the lower plate of the liquid crystal capacitor 202. It must be noted that different sub-pixels may have different channel loading electrical model 500 effects due to their varied distances from the source drivers 101. If per row ON time is long enough, then the targeted voltage level 503 may be settled on the liquid crystal capacitor 202, even if the channel loading electrical model 500 effect may be different for different sub-pixels. If the per row ON time is relatively short, then for the sub-pixels closer to the source drivers 101 may still be well charged or discharged to the targeted voltage level 503, whereas the sub-pixels distanced from the source drivers 101 may not have enough time to settle. It is to be noted that, for a medium resolution TFT LCD panel, the ON time may be enough to reproduce light intensity evenly over the whole TFT LCD panel. Further, for a high resolution TFT LCD panel, the ON time is marginal and may start affecting the light intensity reproduction. Furthermore, for an even higher resolution TFT LCD panel, the on time may not be enough for the sub-pixel 105 at far end. Therefore, a special driving scheme may be needed to counteract the display quality issue.

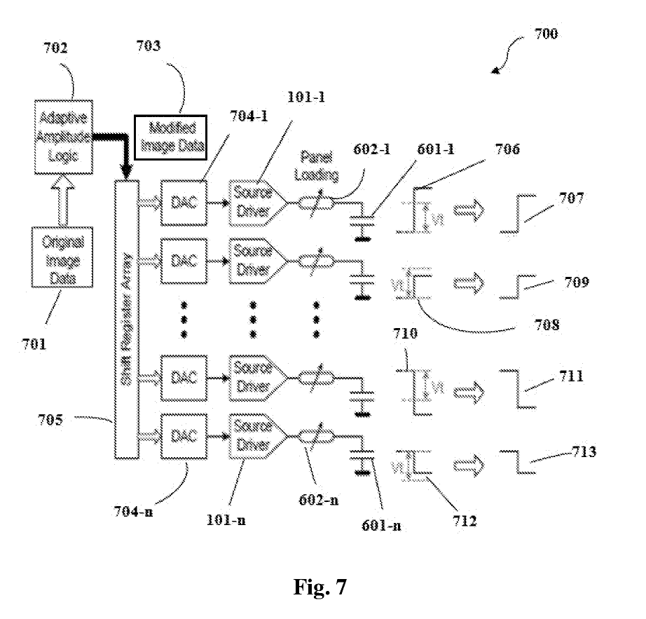

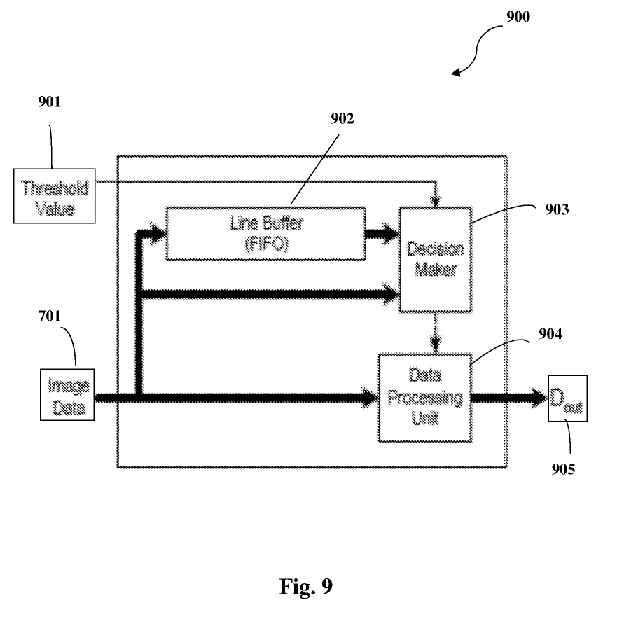

Now referring to FIG. 7, an adaptive amplitude logic unit implementation 700 of an amplitude variation unit coupled with each of the source drivers 101 is illustrated, in accordance with an embodiment of the present application. In one embodiment, the adaptive amplitude logic unit 702 (implemented as an amplitude variation unit) coupled with each of the source drivers 101 may receive original image data 701. The original image data may be conditionally processed by the adaptive amplitude logic unit 702 to obtain modified image data 703 based upon method illustrated in FIG. 9. The original image data 701 or the modified image data 703 may be provided to shift register array 705 the output of which is provided to a plurality of digital-to-analog converters (DAC) 704-1, 704-2 . . . 704-n as shown. The output of DAC may be provided to a plurality of source drivers 101-1, 101-2 . . . 101-n applied with a plurality of panel loadings 602-1, 602-2 . . . 602-n to obtain a plurality of capacitor outputs 601-1, 601-2 . . . 601-n.

Now referring to FIG. 9, the adaptive amplitude logic 702 may further comprise a predefined threshold value 901, a buffer unit 902, a decision-maker unit 903, a data processing unit 904 and the output unit 905. In one embodiment, the buffer unit 902 may store the image data 701 corresponding to a previous scan bus line, from the scan bus lines 103, of the TFT LCD panel 100. The buffer unit 902 may be a first in first out (FIFO) memory array. The buffer unit 902 may be configured to store image data 701 corresponding to one scan bus line, from the scan bus lines 103, at a time such that the receipt of the image data, via the buffer unit 902, corresponding to the subsequent scan bus line for storage may trigger the buffer unit 902 to output the image data 701. The image data 701 outputted may correspond to the previous scan bus line for accommodating the image data 701 corresponding to the subsequent scan bus line. A decision-maker unit 903 may compare the sub-pixel data difference between the image data 701 corresponding to the current scan bus line and the image data 701 corresponding to the previous scan bus line with the predefined threshold value 901. The sub-pixel data difference of the current scan bus line and the previous scan line may be indicative of the amplitude change on the data bus line corresponding to the said image data of the current scan bus line and the previous scan line. The decision-maker unit 903 may be configured to receive the image data 701, via the output from the buffer unit 902, corresponding to the previous scan bus line and current scan bus line. Further, the decision-maker unit 903 may be configured to compare sub-pixel data difference between the image data 701 corresponding to the previous scan bus line and the current scan bus line with the predefined threshold 901. Further, the decision-maker unit 903 may be configured to instruct the data processing unit 904 to modify or retain the image data 701 corresponding to the previous scan line and the current scan bus line based upon the comparison. The data processing unit 904 may modify the image data 701 corresponding to the current scan bus line and the previous scan line by a predefined value if the sub-pixel data difference between the current scan bus line and the previous scan bus line is greater than the predefined threshold 901. It must be noted that the modification of the image data 701 indicates the modification of the amplitude on the data bus line, corresponding to the image data of said current scan bus line and the previous scan bus line, by a predefined value based upon the amplitude change. Further, the data processing unit 904 may modify the image data 701 by either reducing or increasing the amplitude on the data bus line by a predefined value thereby obtaining the modified image data 703.

Now referring to FIG. 7, the modified image data 703 from the adaptive amplitude logic unit 702 may be provided as an input to the shift register array 705. Further, the output from shift register array 705 may be act as an input to the digital to analog convertors (DAC) 704-1, 704-2 . . . 704-n for converting digital modified image data 703 into analog format. Further, the outputs from digital to analog convertors 704-1, 704-2 . . . 704-n may be provided to the source drivers 101-1, 101-2 . . . 101-n. Furthermore, the outputs from the source drivers 101 . . . 101-n may be subjected to panel loadings 602 . . . 602-n in a reduced amount. Further the outputs after the panel loadings 602 may be passed to output capacitors 601.

In an embodiment, as shown in FIG. 7, if the original amplitude change 706 is greater in amplitude than the predefined threshold 901, the adaptive amplitude logic unit 702 may reduce the amplitude of a data bus line, driven by a source driver of the plurality of source drivers 101 based upon the image data of the current scan bus line and the previous scan bus line corresponding to the data bus line, by the predefined value to give a modified reduced amplitude output 707 at the output of the adaptive amplitude logic unit 702. In another embodiment, if the original amplitude change 708 is smaller in amplitude than the predefined threshold 901, the adaptive amplitude logic unit 702 may retain the amplitude of the data bus line same as the original image data 708 to provide an amplitude output 709 at the output of the adaptive amplitude logic unit 702. In yet another embodiment, if the original amplitude change 710 is greater in amplitude than the predefined threshold 901, the adaptive amplitude logic unit 702 may reduce the amplitude of the data bus line by the predefined value to provide a modified reduced amplitude output 711 at the output of the adaptive amplitude logic unit 702. In still another embodiment, if the original amplitude change 712 is smaller in amplitude than the predefined threshold 901, the adaptive amplitude logic unit 702 may retain the amplitude of the data bus line same as the original image data 712 to provide an amplitude output 713 at the output of the adaptive amplitude logic unit 702.

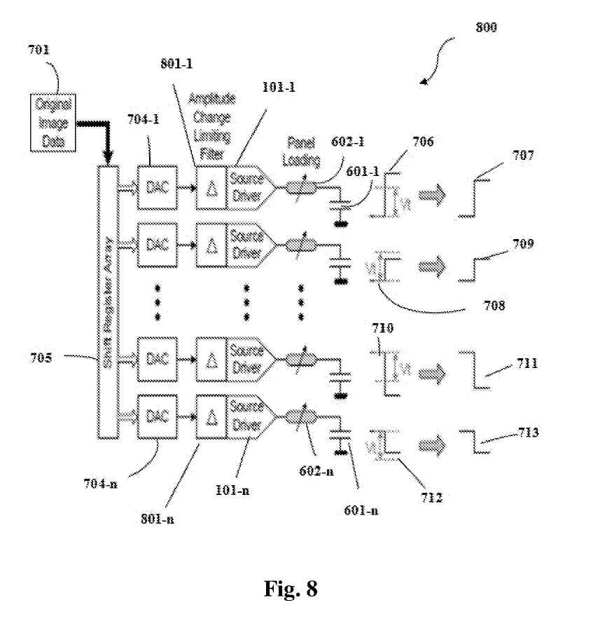

Now referring to FIG. 8, an amplitude change limiting filter-based implementation 800 of an amplitude variation unit coupled with the source drivers 101 is illustrated, in accordance with an embodiment of the present application. In one embodiment, as shown in FIG. 8, an input image data 701 may be provided to shift register array 705. The output of shift register array 705 may be provided to a plurality of digital-to-analog converter (DAC) 704-1, 704-2 . . . 704-n in order to convert the input image data 701 into analog format or analog voltages. Further, the analog voltages may be provided to a plurality of amplitude change limiting filters 801-1,801-2 . . . 801-n which either reduces or retains the amplitude.

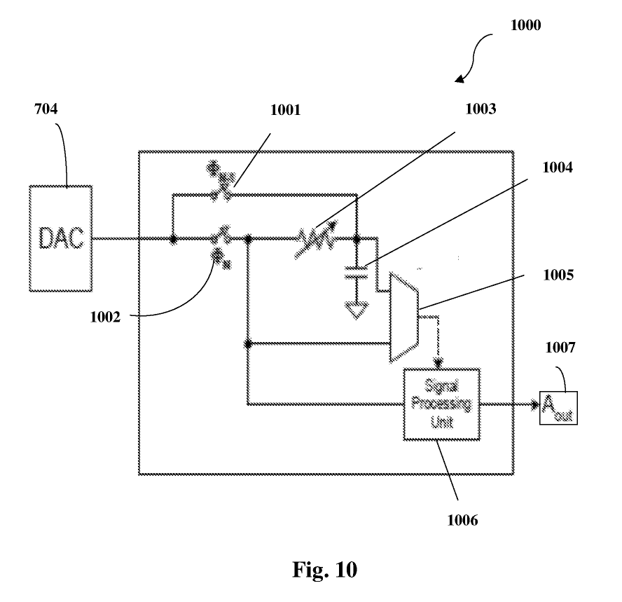

As shown in FIG. 10, each amplitude change limiting filter 801 may further comprise a first switch 1001, a second switch 1002, a programmable resistor 1003, a capacitor 1004, a comparator 1005, a signal processing unit 1006, and an output unit 1007. The first switch 1001 may be turned ON to store the analog voltage, corresponding to image data 701 associated to a previous scan bus line, on the capacitor 1004. The second switch 1002 may be turned ON to charge the capacitor 1004 by an analog voltage, corresponding to image data 701 associated to the current scan bus line and the programmable resistor 1003. According to the setting of the resistor 1003 and the voltage difference between the previous scan bus line and the current scan bus line, after a predefined time period, the voltage on the capacitor 1004 may be near or far away from the analog voltage corresponding to the sub-pixel data of the current scan bus line and previous scan bus line. The comparator 1005 may be configured to compare the potential difference between the two terminals of the comparator 1005 and instruct the signal processing unit 1006 to perform signal processing for the analog voltage corresponding to the sub-pixel data. The signal processing unit 1006 may perform signal processing if the voltage difference between the two terminals of the comparator 1005 is larger than the voltage difference between the previous scan bus line and the current scan bus line. Further, the signal processing unit 1006 may be configured to decrement the analog voltage by a predefined value Delta_H for the analog voltages with higher values and to increment the analog voltages by a predefined value Delta_L for the analog voltages with lower values. The output from the signal processing unit 1006 may be passed to the output unit 1007.

Now referring to FIG. 8, the output from the amplitude change limiting filter 801 may be passed to the source drivers 101-1, 101-2 . . . 101-n. Further, the output from the source drivers 101-1, 101-2 . . . 101-n may be subjected to panel loadings 602-1, 602-2 . . . 602-n in a reduced amount. Further the outputs after the panel loadings 602 may be passed to output capacitors 601. In an embodiment, if the original amplitude change 706 is greater in amplitude than the predefined threshold 901, each amplitude change limiting filter 801 may reduce the amplitude of a data bus line, driven by a source driver of the plurality of source drivers 101 based upon the image data of a current scan bus line and a previous scan bus line corresponding to the data bus line, by the predefined value to provide a modified reduced amplitude output 707 at the output of each amplitude change limiting filter 801. In another embodiment, if the original amplitude change 708 is smaller in amplitude than the predefined threshold 901, each amplitude change limiting filter 801 may retain the amplitude of the data bus line same as the original image data 708 to provide an amplitude output 709 at the output of each amplitude change limiting filter 801. In yet another embodiment, if the original amplitude change 710 is greater in amplitude than the predefined threshold 901, each amplitude change limiting filter 801 may reduce the amplitude of the data bus line by the predefined value to provide a modified reduced amplitude output 711 at the output of each amplitude change limiting filter 801. In still another embodiment, if the original amplitude change 712 is smaller in amplitude than the predefined threshold 901, each amplitude change limiting filter 801 may retain the amplitude of the data bus line same as the original image data 712 to provide an amplitude output 713 at the output of each amplitude change limiting filter 801.

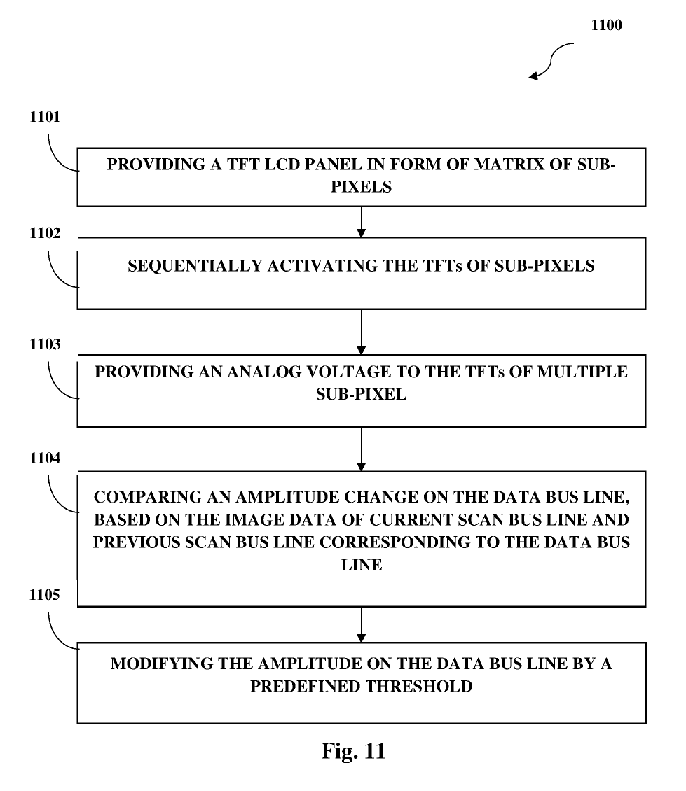

Now referring to FIG. 11, a method 1100 enabling adaptive source driving for a thin film transistor (TFT) liquid crystal display (LCD) panel is illustrated, in accordance with an embodiment of the present application.

As shown in FIG. 11, at block 1101, a TFT LCD panel in a form of matrix of data bus lines 104 and scan bus lines 103 arranging sub-pixels 105-1, 105-2 . . . 105-n may be provided. In an aspect, an intersection of a data bus line from the data bus line 104 and a scan bus line from the scan bus lines 103, in the matrix, may be a cell depicting a sub-pixel 105 of the plurality of sub-pixels 105-1, 105-2 . . . 105-n. Each sub-pixel 105 comprises a TFT 106.

At block 1102, the TFTs 106-1, 106-2 . . . 106-m of sub-pixels 105-1, 105-2 . . . 105-n belonging to one scan bus line 103 after the other may be sequentially activated by the gate drivers 102. The gate drivers 102 may be connected to a gate terminal of the plurality of TFTs 106 of the plurality of sub-pixels 105 via the scan bus lines 103.

At block 1103, a charge may be provided, via the source drivers 101, to the multiple sub-pixels 105 belonging to each scan bus line 103 being activated, one after the other, by the said gate drivers 102. Each of the multiple sub-pixels 105 on a scan bus line 103 may be charged to render an image on the TFT LCD panel 100 based upon image data 701 corresponding to the multiple sub-pixels on the said scan bus line 103. The source drivers 101 may be connected to a source terminal of the plurality of TFTs 106 of the plurality of sub-pixels 105 via the data bus lines 104.

At block 1104, an amplitude change on a data bus line, driven by a source driver of the plurality of source drivers 101, may be compared based upon the image data corresponding to the sub-pixels of a current scan bus line and a previous scan bus line corresponding to the said data bus line. In one embodiment, the amplitude change on the data bus line may be compared via an amplitude variation unit (i.e. either the adaptive amplitude logic 702 or the amplitude change limiting filter 801) coupled with the said source driver of the plurality of source drivers 101.

At block 1105, the amplitude on the said data bus line may be modified by a predefined value if the amplitude change is greater than a predefined threshold 901. In one embodiment, the amplitude on the said data bus line may be modified via the amplitude variation unit (i.e. either the adaptive amplitude logic 702 or the amplitude change limiting filter 801).

In one example, assume a threshold value Vₜ=120, Delta_H=8 and Delta_L=16 is predefined for a conventional a-Si panel. In this example, consider the source driver drives the panel loading in the order of R1->R2->R3 sequentially. Therefore, in this case, the amplitude change for the original data to obtain modified data will be as below:

Exemplary embodiments discussed above may provide certain advantages. These advantages may include those provided by the following features.

Some embodiments of the present application may provide a TFT display panel with improved visual performance for killer patterns.

Some embodiments of the present application may provide a TFT display panel with reduced power consumption for killer patterns.

Some embodiments of the present application may provide a TFT display panel with lossless visual feeding for general images.

Some embodiments of the present application may provide a TFT display panel with less coupling to VCOM.

Although implementations for a thin film transistor (TFT) liquid crystal display (LCD) panel have been described in language specific to structural features and/or methods, it is to be understood that the appended claims are not necessarily limited to the specific features or methods described. Rather, the specific features and methods are disclosed as examples of implementations for an amplitude variation unit coupled with the source driver for a TFT LCD panel. The predefined threshold value for the TFT LCD panel may be adjustable by the users to cater for different panel displays and different brightness of red/green/blue (RGB) sub-pixels and gray levels.

What is claimed is:

1. A thin film transistor (TFT) liquid crystal display (LCD) panel, comprising:
a matrix of data bus lines and scan bus lines arranging a plurality of sub-pixels, wherein an intersection of a data bus line and a scan bus line, in the matrix, is a cell depicting a sub-pixel of the plurality of sub-pixels, and wherein each sub-pixel comprises a TFT;
a plurality of gate drivers connected with a gate terminal of a plurality of TFTs of the plurality of sub-pixels via the scan bus lines, wherein the plurality of gate drivers is configured to sequentially activate the TFTs of multiple sub-pixels, of the plurality of sub-pixels, belonging to one scan bus line after the other;
a plurality of source drivers connected with a source terminal of the plurality of TFTs of the plurality of sub-pixels via the data bus lines, wherein the plurality of source drivers is configured to charge the multiple sub-pixels on each scan bus line being activated, one after the other, by the plurality of gate drivers, and wherein multiple sub-pixels on a scan bus line are charged to render an image on the TFT LCD panel based upon image data corresponding to the multiple sub-pixels on the said scan bus line; and
an amplitude variation unit coupled with a source driver, of the plurality of source drivers, wherein the amplitude variation unit is configured to
compare an amplitude change on a data bus line driven by the said source driver based upon the image data of a current scan bus line and a previous scan bus line corresponding to the said data bus line and
modify the amplitude on the said data bus line by a predefined value if the amplitude change is greater than a predefined threshold value.

2. The TFT LCD panel of claim 1, wherein each sub-pixel further comprises a storage capacitor and a liquid crystal capacitor.

3. The TFT LCD panel of claim 2, wherein one plate of storage capacitor is formed by a display electrode and the other plate is formed by using either the scan bus lines or a common electrode.

4. The TFT LCD panel of claim 1, wherein the amplitude variation unit further comprises one of an adaptive amplitude logic unit or one or more amplitude change limiting filters.

5. The TFT LCD panel of claim 4, wherein the adaptive amplitude logic unit further comprises:
a buffer unit to store image data corresponding to the previous scan bus line of the TFT LCD panel;
a decision-maker unit to compare a sub-pixel data difference between the image data corresponding to the current scan bus line and the image data corresponding to the previous scan bus line with a predefined threshold value, wherein the sub-pixel data difference of scan bus lines is indicative of the amplitude change on the data bus line based upon the image data of said previous scan bus line and the current scan bus line corresponding to the data bus line; and
a data processing unit to modify the image data corresponding to the previous scan bus line and the current scan bus line by a predefined value if the sub-pixel data difference of scan bus lines is greater than a predefined threshold, wherein the modification of the image data indicates the modification of the amplitude on the data bus line based upon the image data of previous scan bus line and the current scan bus line corresponding to the data bus line.

6. The TFT LCD panel of claim 5, wherein the buffer unit is a first in first out (FIFO) memory array, wherein the buffer unit is configured to store image data corresponding to sub-pixels belonging to one scan bus line at a time such that receipt of the image data, via the buffer unit, corresponding to the subsequent scan bus line for storage triggers the buffer unit to output the image data corresponding to the previous scan bus line for accommodating the image data corresponding to the subsequent scan bus line.

7. The TFT LCD panel of claim 6, wherein the decision-maker unit is configured to:
receive, via the output from the buffer unit, the image data corresponding to the previous scan bus line;
receive image data corresponding to the current scan bus line;
compare sub-pixel data difference between image data corresponding to the previous scan bus line and the image data corresponding to the current scan bus line with a predefined threshold value; and
instruct the data processing unit to modify or retain the image data corresponding to the previous scan line and the current scan bus line based upon the comparison.

8. The TFT LCD panel of claim 7, wherein the data processing unit modifies the image data corresponding to the current scan bus line and the previous scan line if the sub-pixel data difference of the scan bus lines is greater than the predefined threshold value.

9. The TFT LCD panel of claim 8, wherein the data processing unit modifies the image data by either reducing or increasing the amplitude on the data bus line by a predefined value, wherein the amplitude on the data bus line is either reduced or increased based upon the image data of the current scan bus line and the previous scan line corresponding to the data bus line.

10. The TFT LCD panel of claim 4, wherein the amplitude change limiting filters comprises:
a first switch, wherein the first switch is turned ON to store an analog voltage, corresponding to image data associated to a previous scan bus line, on a capacitor;
a second switch, wherein the second switch is turned ON to charge the capacitor by an analog voltage corresponding to image data associated to a current scan bus line and a programmable resistor;
a comparator to compare potential difference between the two terminals comprising voltage difference between the previous scan bus line and current scan bus line; and
a signal processing unit to perform signal processing if the voltage difference between the two terminals of the comparator is larger than the voltage difference between the previous scan bus line and the current scan bus line.

11. The TFT LCD panel of claim 10, wherein the amplitude change limiting filters receive analog input from one or more digital-to-analog units.

12. The TFT LCD panel of claim 11, wherein the digital-to-analog converters provides the analog voltage to the amplitude limiting filters corresponding to consecutive sub-pixels on the panel.

13. The TFT LCD panel of claim 10, wherein the first switch is turned on after the sub-pixel data is converted by into an analog voltage the digital-to-analog converter.

14. The TFT LCD panel of claim 10, wherein the second switch is turned on after sub-pixel data is converted, by the digital-to-analog converter, into analog voltage.

15. The TFT LCD panel of claim 10, wherein the comparator instructs the signal processing unit to perform signal processing for the analog voltage corresponding to the sub-pixel data if the voltage difference between the second and the first scan bus line is larger than the threshold.

16. The TFT LCD panel of claim 10, wherein the signal processing unit is configured to:
decrement the analog voltage by a predefined value Delta_H for the analog voltages with higher values; and
increment the analog voltages by a predefined value Delta_L for the analog voltages with lower values.

17. A method enabling adaptive source driving for a thin film transistor (TFT) liquid crystal display (LCD) panel, the method comprising:
providing a TFT LCD panel in form of matrix comprising data bus lines and scan bus lines arranging a plurality of sub-pixels, wherein an intersection of a data bus line and a scan bus line, in the matrix, is a cell depicting a sub-pixel of the plurality of sub-pixels, and wherein each sub-pixel comprises a TFT;
sequentially activating, via a plurality of gate drivers, TFTs of multiple sub-pixels, of the plurality of sub-pixels, belonging to one scan bus line after the other, wherein the plurality of gate drivers is connected to a gate terminal of the plurality of TFTs of the plurality of sub-pixels via the scan bus lines;
providing, via a plurality of source drivers, a charge to the multiple sub-pixels belonging to each scan bus line being activated, one after the other, by the plurality of gate drivers, wherein multiple sub-pixels on a scan bus line are charged to render an image on the TFT LCD panel based upon image data corresponding to the multiple sub-pixels on the said scan bus line, and wherein the source driver is connected to a source terminal of the plurality of TFTs of the plurality of sub-pixels via the data bus lines;
comparing, via an amplitude variation unit coupled with a source driver of the plurality of source drivers, an amplitude change on a data bus line, driven by the said source driver, based upon the image data of a current scan bus line and a previous scan bus line corresponding to the said data bus line; and
modifying, via the amplitude variation unit, the amplitude on the said data bus line by a predefined threshold value if the amplitude change is greater than a predefined threshold value.

18. The method of claim 17, wherein modifying the analog voltage of the current scan bus line and previous scan bus line is performed either by increasing or decreasing the said analog voltage by the predefined value depending upon the input image data.

19. The method of claim 17, wherein the predefined threshold value is adjustable by the users to cater for different panel displays.

20. The method of claim 17, wherein the predefined threshold value is adjustable by the users to cater for different brightness of RGB sub-pixels and gray levels.
